(19) United States
(12) Patent Application Publication
(10) Pub. No.: US 2012/0263972 A1
(43) Pub. Date: Oct. 18, 2012

(54) Method for Carrying out Diffusion Treatment on Coating of Engineering Parts Resistant to Marine Climate

(75) Inventors: Lixin Feng, Wuxi (CN); Minyan Zhang, Wuxi (CN); Qiang Miao, Wuxi (CN)

(73) Assignee: JIANGSU LINLONG NEW MATERIALS CO., LTD., Wuxi, Jiangsu (CN)

(21) Appl. No.: 13/127,222

(22) PCT Filed: Mar. 31, 2010
(86) PCT No.: PCT/CN2010/071484

§ 371 Date: May 2, 2011

(30) Foreign Application Priority Data
Dec. 28, 2009 (CN) 200910262715.3

(51) Int. Cl. C23C 8/80; C23C 8/40; B32B 15/01; C23C 8/02

(52) U.S. Cl. 428/686; 148/537

(57) ABSTRACT

The invention relates to a method for carrying out the diffusion treatment on the coating of engineering parts resistant to marine climate. The method comprises the following steps: 1. pre-treating the parts; 2. pre-heating the parts in a protective atmosphere furnace; 3. immersing the pre-heated parts in a plating solution in away that the parts are rotated in the submerging process; 4. undergoing the diffusion treatment, particularly, putting the immersion-plated parts into a vacuum furnace, holding at 800 to 950 DEG C for 1 to 3 hours, then reducing the temperature gradually and taking out the parts, and forming a diffusion layer on a substrate through the diffusion of atoms at the interface to achieve the metallurgical combination between the coating and the substrate. The parts treated by the method of the invention are highly resistant to corrosion and scouring erosion under the condition of marine climate.

### FIELD OF THE INVENTION

The invention relates to a method for carrying out diffusion treatment on coating of engineering parts resistant to marine climate.

### BACKGROUND OF THE INVENTION

With the rapid growth of science and technology, more and more engineering equipment is applied in offshore water and ocean, but its service environment is generally higher than level C5 according to ISO 9225 environmental assessment standard and belongs to extremely harsh environment with rainy, high temperature, salt misty and strong wind. Comprehensive actions of strong atmospheric corrosion, electrochemical corrosion and current scour corrosion on exposed parts cause service lives of various steel structures to be far shorter than that in the common inland outdoor environment. For example, wind power generating device, one of typical engineering devices, services under marine climate, and because wind turbines utilize wind energy to generate electricity, and there is rich wind resources at coast lines and offshore waters, most wind power plants are located at coastal or offshore waters. Wind turbines serviced in marine climate with common protective measures are usually seriously corroded within only a couple of months because the external members, such as engine rooms, engine covers, tower structures, etc., are directly exposed in extremely corrosive atmosphere, which brings about huge losses. According to statistics, the loss caused by marine corrosion accounts for one third of total loss, and the loss of accidents caused by marine corrosion is uncountable. For instance, in 1969 a Japanese 50,000 dwt special ore transport vessel suddenly sank due to corrosion brittle damage. Therefore, it is strategically significant to enhance corrosion control and reduce the loss of metal material to prevent equipment from suffering premature or accidental damage in marine environment.

The rapid growth of modern surface engineering technology provides diverse solutions such as electroplating, chemical plaiting, thermal spraying, vapor deposition, etc. for corrosion protection on surface of steel. But the above present solutions have certain problems, in which the common problems are complex processes and high production cost, and more seriously, a coating obtained by the above methods is easily flake off resulting in failure under synergetic effect of stress and environment. Therefore, it has been an urgent need of present industry development to develop effective novel process for improving combination strength between a coating and a substrate.

### SUMMARY OF THE INVENTION

In view of the problems of the prior art, the invention provides a method for carrying out diffusion treatment on coating of engineering parts resistant to marine climate to thoroughly solve the problems existing in the prior art.

The method for carrying out diffusion treatment on coating of engineering parts resistant to marine climate provided by the invention comprises:

a first step: pre-treating parts;

a second step: preheating the parts in a protective atmosphere furnace;

a third step: immersing the preheated parts in a plating solution in a way that the parts are rotated in the submerging process; and

a fourth step: undergoing diffusion treatment, particularly, putting the immersion-plated parts into a vacuum furnace, holding at 800-950° C. for 1-3 hours, then, reducing the temperature gradually and taking out the parts, and forming a diffusion layer on a substrate through the diffusion of atoms at the interface to achieve the metallurgical combination between the coating and the substrate.

Preferably, the pretreatment of the parts in the first step includes degreasing, derusting and etching.

More preferably, in said etching treatment, the parts after degreasing and derusting are put into mixed solution of hydrochloric acid and hydrofluoric acid for etching 1-3 minutes at room temperature, wherein said hydrochloric acid HCl accounts for 94-96% in volume and said hydrofluoric acid HF 4-6% in volume of the mixed solution of hydrochloric acid and hydrofluoric acid.

Preferably, in the second step, said parts are preheated in the protective atmosphere furnace for 10-20 minutes at temperature of 500-650° C.

Preferably, in the third step, the preheated parts are put in the plating solution for 1-5 minutes, wherein said plating solution mainly contains Zn, Al, Si, RE, microalloy elements and nanometer oxide particle reinforcing agent; said nanometer oxide particle reinforcing agent is selected from one of two of TiO₂ and CeO₂; said microalloy elements are selected from one or more than one of Mg, Ti and Ni, and the mass percentages of the components of the plating solution are as follows: Zn: 35-58%, Si: 0.3-4.0%, RE: 0.02-1.0%, the total content of the nanometer oxide particle reinforcing agent: 0.01-1.0%, the total content of the microalloy elements: 0.01-6.0%, and Al: the balance.

More preferably, the average particle size of said nanometer oxide particle reinforcing agent is 15-60 nm.

More preferably, the mass percentages of the specific adding amounts of the components of said microalloy elements are as follows: Mg: 0.1-5.0%, Ti: 0.01-0.5%, and Ni: 0.1-3.0%.

Preferably, in the fourth step, the thickness of the diffusion layer formed on the substrate through the diffusion of atoms at the interface is 10-30 μm.

In another aspect, the invention further provides a part having a coating with diffusion treatment resistant to marine climate, wherein the thickness of the coating on the surface of the part is 200-300 μm, said coating contains a diffusion layer formed on a substrate through the diffusion of atoms at the interface, the coating is metallurgically combined with the substrate via the diffusion layer, and the thickness of the diffusion layer is 10-30 μm.

Preferably, the diffusion layer is formed through the following process:

a first step: pre-treating the part;

a second step: preheating the part in a protective atmosphere furnace;

a third step: immersing the preheated part in a plating solution in a way that the part is rotated in the submerging process; and

a fourth step: undergoing diffusion treatment, particularly, putting the immersion-plated part in a vacuum furnace, holding at 800-950° C. for 1-3 hours, then, reducing the temperature gradually and taking out the part and forming a diffusion layer on a substrate through the diffusion of atoms at the interface to achieve the metallurgical combination between the coating and the substrate.

The part to be immersion-plated is put into the protective atmosphere furnace for preheating for a while before the immersion plating to reduce mechanical property mismatch between the coating and the substrate, so that the coating can not flake off even under the action of a contact fretting load.

On the other hand, the coating formed by the plating solution of the invention has significantly improved capacity resisting to atmosphere corrosion, electrochemical corrosion and air current scouring erosion as well as remarkably enhanced strength, hardness and scouring resistance.

Furthermore, in the invention, a step of diffusion treatment is additionally provided after immersion plating, so that the coating is firmly combined with the substrate and can not easily flake off even under the synergetic effect of stress and environment, thereby having favorable protecting effect and being totally suitable for extremely harsh environments such as marine environment, etc.

In inclusion, compared with the prior art the invention has simplified production process, low cost and wide adjustable range of thickness of the coating; the coating has better corrosion and wear resistances and firm combination with the substrate, does not easily flake off and is suitable for parts having different sizes. The method has simple process and low production cost and is suitable for parts having different sizes and in any shape. The parts treated by the invention are highly resistant to corrosion and scouring erosion under the condition of marine climate.

### DETAILED DESCRIPTIONS OF THE INVENTION

The invention provides a method for carrying out diffusion treatment on coating of engineering parts resistant to marine climate, comprising:

a first step: pre-treating parts;

a second step: preheating the parts in a protective atmosphere furnace;

a third step: immersing the preheated parts in a plating solution in a way that the parts are rotated in the submerging process; and

a fourth step: undergoing diffusion treatment, particularly, putting the immersion-plated parts into a vacuum furnace, holding at 800-950° C. for 1-3 hours, then, reducing the temperature gradually and taking out the parts, and forming a diffusion layer on a substrate through the diffusion of atoms at the interface to achieve the metallurgical combination between the coating and the substrate.

The following are prefer embodiments of the diffusion treatment method for preparing anticorrosion coating on the surface of steel structure parts resistant to marine climate. It is noted that conditions of the following embodiments are described as non-essential technical features, and those skilled in the art can carry out reasonable generalization and deduction on the basis of values listed in the embodiments.

### Embodiment 1

(1) A part is cleaned and degreased, then undergoes derusting through acid cleaning and is rinsed by deionized water.

(2) The part after degreasing and derusting treatments is etched in mixed solution containing 94% of hydrochloric acid HCl in volume and 6% of hydrofluoric acid HF in volume for 1 minute at room temperature and then is rinsed by deionized water.

(3) The part after the treatments of (1) and (2) is put into a protective atmosphere furnace and preheated for 20 minutes at 500° C.

(4) In the protective atmosphere furnace, the preheated steel part is immersed in a plating solution for 1 minute in a way that the part is rotated in the submerging process.

(5) The immersion-plated part is put in a vacuum furnace for preservation for 3 hours at 800° C. and taken out after the temperature falls gradually whereby a diffusion layer is formed under the coating, and a protective plating diffusion composite layer is formed on the surface of the part through the above processes.

### Embodiment 2

(1) A part is cleaned and degreased, then undergoes derusting through acid cleaning and is rinsed by deionized water.

(2) The part after degreasing and derusting treatments is etched in mixed solution containing 95% of hydrochloric acid HCl in volume and 5% of hydrofluoric acid HF in volume for 2 minute at room temperature and then is rinsed by deionized water.

(3) The part after the treatments of (1) and (2) is put into a protective atmosphere furnace and preheated for 15 minutes at 600° C.

(4) In the protective atmosphere furnace, the preheated steel part is immersed in a plating solution for 3 minute in a way that the part is rotated in the submerging process.

(5) The immersion-plated part is put in a vacuum furnace for preservation for 2 hours at 880° C. and taken out after the temperature falls gradually whereby a diffusion layer is formed under the coating, and a protective plating diffusion composite layer is formed on the surface of the part through the above processes.

### Embodiment 3

(1) A part is cleaned and degreased, then undergoes derusting through acid cleaning and is rinsed by deionized water.

(2) The part after degreasing and derusting treatments is etched in mixed solution containing 96% of hydrochloric acid HCl in volume and 4% of hydrofluoric acid HF in volume for 3 minute at room temperature and then is rinsed by deionized water.

(3) The part after the treatments of (1) and (2) is put into a protective atmosphere furnace and preheated for 10 minutes at 650° C.

(4) In the protective atmosphere furnace, the preheated steel part is immersed in a plating solution for 5 minute in a way that the part is rotated in the submerging process.

(5) The immersion-plated part is put in a vacuum furnace for preservation for 1 hours at 950° C. and taken out after the temperature falls gradually whereby a diffusion layer is formed under the coating, and a protective plating diffusion composite layer is formed on the surface of the part through the above processes.

In the embodiments 1-3, the plating solution has the following components and contents thereof shown in table 1. It is noted that table 1 merely shows prefer embodiments of the plating solutions of the invention, although microalloy elements in table 1 simultaneously include Mg, Ti and Ni, this is described as non-essential technical features, and the microalloy elements of the invention can be selected form any one, two or three of Mg, Ti and Ni, and similarly, although said nanometer oxide particle reinforcing agent listed in table 1 is TiO₂, the nanometer oxide particle reinforcing agent of the invention can be CeO₂ or both.

TABLE 1
Mass Percentage (%) of Components of the Total

| | Element | | | | | | | |
|---|---|---|---|---|---|---|---|---|
| Serial number | Al | Zn | Si | RE | Mg | Ti | Ni | TiO₂ |
| 1 | balance | 35 | 4.0 | 1.0 | 0.1 | 0.5 | 0.1 | 1.0 |
| 2 | balance | 36 | 3.9 | 0.9 | 0.3 | 0.48 | 0.2 | 0.9 |
| 3 | balance | 37 | 3.8 | 0.8 | 0.5 | 0.45 | 0.3 | 0.8 |
| 4 | balance | 39 | 3.6 | 0.6 | 0.8 | 0.40 | 0.5 | 0.6 |
| 5 | balance | 41 | 3.2 | 0.4 | 1.0 | 0.35 | 0.7 | 0.4 |
| 6 | balance | 43 | 2.8 | 0.3 | 1.3 | 0.30 | 1.0 | 0.3 |
| 7 | balance | 45 | 2.5 | 0.2 | 1.8 | 0.25 | 1.3 | 0.2 |
| 8 | balance | 47 | 2.2 | 0.15 | 2.2 | 0.20 | 1.5 | 0.15 |
| 9 | balance | 49 | 1.8 | 0.13 | 2.6 | 0.15 | 1.8 | 0.13 |
| 10 | balance | 51 | 1.5 | 0.11 | 3.0 | 0.1 | 2.0 | 0.11 |
| 11 | balance | 53 | 1.0 | 0.09 | 3.5 | 0.08 | 2.4 | 0.09 |
| 12 | balance | 55 | 0.8 | 0.07 | 4.0 | 0.05 | 2.6 | 0.07 |
| 13 | balance | 56 | 0.5 | 0.05 | 4.5 | 0.03 | 2.8 | 0.05 |
| 14 | balance | 57 | 0.4 | 0.03 | 4.8 | 0.02 | 2.9 | 0.03 |
| 15 | balance | 58 | 0.3 | 0.02 | 5.0 | 0.01 | 3.0 | 0.01 |

Preferably, the average particle size of said nanometer oxide particle reinforcing agent is 15-60 nm.

Preferably, the mass percentages of the specific adding amounts of the components of said microalloy elements are as follows: Mg: 0.1-5.0%, Ti: 0.01-0.5%, and Ni: 0.1-3.0%.

In another aspect, the invention further provides a part having a coating with diffusion treatment resistant to marine climate, wherein the thickness of the coating on the surface of the part is 200-300 μm, said coating contains a diffusion layer formed on a substrate through the diffusion of atoms at the interface, the coating is metallurgically combined with the substrate via the diffusion layer, and the thickness of the diffusion layer is 10-30 μm. Prefer embodiments of the coating with diffusion treatment of the invention are hereinafter given in table 2:

TABLE 2
Thickness Unit (μm)

| | | Thickness of | Bonding | |
|---|---|---|---|---|
| Serial | Thickness of | diffusion | force of | Corrosion |
| number | coating | layer | coating | resistance |
| 1 | 200 | 10 | Level 1 | Better |
| 2 | 210 | 11 | Level 1 | Better |
| 3 | 220 | 13 | Level 1 | Excellent |
| 4 | 235 | 16 | Level 1 | Excellent |
| 5 | 250 | 19 | Level 1 | Excellent |
| 6 | 260 | 21 | Level 1 | Excellent |
| 7 | 270 | 25 | Level 1 | Excellent |
| 8 | 290 | 28 | Level 2 | Excellent |
| 9 | 300 | 30 | Level 2 | Excellent |

Note:
method for testing bonding force of coating is carried out by referring to GB1720-79

In conclusion, the foregoing prefer embodiments are merely illustrative of the invention, but the concept of the invention are not to be construed in a limiting sense, and non-essential modifications of the invention on this basis are seen to fall within the scope of the invention.

What is claimed is:

1. A method of carrying out diffusion treatment for a coating of engineering part being resistant to marine climate, comprising:
first step, pre-treating part;
second step, preheating the part in a protective atmosphere furnace;
third step, submerging the preheated part in a plating solution, turning the part during the submerging process; and
fourth step, making diffusion treatment, putting the immersion-plated part into a vacuum furnace, holding at 800-950° C. for 1-3 hours, then reducing the temperature gradually and taking out the parts, and finally forming a diffusion layer on a substrate through the diffusion of atoms at the interface to achieve the metallurgical combination between the coating and the substrate.

2. The method according to claim 1, wherein the pretreatment of the part in the first step includes degreasing, derusting and etching.

3. The method according to claim 2, wherein said etching treatment includes that the parts after degreasing and derusting are put into mixed solution of hydrochloric acid and hydrofluoric acid for etching of 1-3 minutes at room temperature, wherein said hydrochloric acid (HCl) accounts for 94-96% in volume and said hydrofluoric acid (HF) for 4-6% in volume of the mixed solution.

4. The method according to claim 1, wherein in the second step, said parts are preheated in the protective atmosphere furnace for 10-20 minutes at a temperature of 500-650° C.

5. The method according to claim 1, wherein in the third step, the preheated parts are put in the plating solution for 1-5 minutes, wherein said plating solution mainly contains Zn, Al, Si, RE, microalloy elements and nanometer oxide particle reinforcing agent, wherein said nanometer oxide particle reinforcing agent is selected from one of two of TiO₂ and CeO₂, and said microalloy elements are selected from one or more than one of Mg, Ti and Ni, and the mass percentages of the components of the plating solution are as follows: Zn: 35-58%, Si: 0.3-4.0%, RE: 0.02-1.0%, the total content of the nanometer oxide particle reinforcing agent: 0.01-1.0%, the total content of the microalloy elements: 0.01-6.0%, and Al: the remainder.

6. The method according to claim 5, wherein the average particle size of said nanometer oxide particle reinforcing agent is 15-60 nm.

7. The method according to claim 5, wherein the mass percentages of the specific adding amounts of the components of said microalloy elements are as follows: Mg: 0.1-5.0%, Ti: 0.01-0.5%, and Ni: 0.1-3.0%.

8. The method according to claim 1, wherein in the fourth step, the thickness of the diffusion layer formed on the substrate through the diffusion of atoms at the interface is 10-30 μm.

9. A part having a coating with diffusion treatment to be resistant to marine climate, wherein the thickness of the coating on the surface of the part is 200-300 μm, wherein said coating contains a diffusion layer formed on a substrate through the diffusion of atoms at the interface which leads to the metallurgical combination of the coating and the substrate, and the thickness of said diffusion layer is 10-30 μm.

10. The part according to claim 9, wherein said diffusion layer is formed through the following steps:
a first step: pre-treating the part;
a second step: preheating the part in a protective atmosphere furnace;
a third step: immersing the preheated part in a plating solution in a way that the part is rotated in the submerging process; and
a fourth step: undergoing diffusion treatment, particularly, putting the immersion-plated part in a vacuum furnace, holding at 800-950° C. for 1-3 hours, then reducing the temperature gradually and taking out the part, and finally forming a diffusion layer on a substrate through the diffusion of atoms at the interface to achieve the metallurgical combination of the coating and the substrate.
